(19) United States
(12) Patent Application Publication
(10) Pub. No.: US 2016/0009506 A1
(43) Pub. Date: Jan. 14, 2016

(54) Bale Loading Method and Apparatus

(71) Applicant: Gary L. Kelderman, Oskaloosa, IA (US)

(72) Inventor: Gary L. Kelderman, Oskaloosa, IA (US)

(21) Appl. No.: 14/326,149

(22) Filed: Jul. 8, 2014

(51) Int. Cl. B65G 67/08; B65G 67/20; B65G 43/00; B65G 49/00; B65G 17/40; B65G 15/28

(52) U.S. Cl. CPC B65G 67/08; B65G 17/40; B65G 15/28; B65G 43/00; B65G 49/00; B65G 67/20; B65G 2201/0223; B65G 2201/0202; B65G 2203/042; B65G 2812/02089; B65G 2812/02128; B65G 2812/02267

(57) ABSTRACT

An apparatus for loading a container with stacks of bales comprising biomass. Conveyors are driven from a mid-point between the ends of the container, thus reducing the strain on the conveyor material. Squeeze flaps help guide the stacks of bales into the container, and provide the ability to reduce the width of the bale stack by hydraulically actuating the squeeze flaps. A remote control device is used in the process of loading and a sensor senses when the container is full.

### BACKGROUND OF THE INVENTION

1. Field of the Invention

This invention relates generally to a device for loading bales of biomass into a container for transporting to another location, and more particularly to a bale loading apparatus that simplifies and speeds up the loading process.

2. Background Art

U.S. Pat. No. 8,408,857to a Bale Picking Truck by Kelderman shows a method and apparatus for quickly and efficiently picking up and removing biomass bales from a field in which the biomass was baled, compactly stacking the bales after picking the bales off the ground, and efficiently depositing the bales on the ground or platform at a staging area for later loading onto a semi-trailer, straight truck, or train car.

Published U.S. Patent Application No. 2012/0045310 to a Bale De-Stacker by Kelderman relates to a method and apparatus for efficiently unstacking square bales from a stack and conveying the square bales in small sets or individually once they arrive from their aforementioned staging area to the place they are to be used, such as in an ethanol production plant, a plant where the bales are to be burned for fuel, or a feedlot.

U.S. Pat. No. 8,734,077 to a Bale Loading Trailer and Method of Using Same by Kelderman relates to the step of picking sets of bales off the ground, such as at the aforementioned staging area, and loading said bales into a trailer via a moving floor. The aforementioned patents and Published U.S. Patent Application are hereby incorporated herein by reference in their entirety.

### SUMMARY OF THE INVENTION

The present invention is an improvement over that disclosed in U.S. Pat. No. 8,734,077. The moving floor of the present invention comprises a hydraulic, electric, or other motor disposed approximately midway along the direction the bales are moved. The motor drives two sets of chains or belts, or any equivalent thereof. The first set of chains or belts is disposed rearmost in the container, while the second set is disposed front-most in the container. During loading from the rear of the container, the first set of chains can transfer sets of bales approximately up to the drive motor while the second set of chains can transfer sets of bales to the front of the container. In unloading, the second set of chains transfer sets of bales to the proximity of the drive motor, while the first set of chains deliver sets of bales to the rear of the container for unloading.

An advantage of locating the motor such that conveyors are disposed on both sides thereof is a reduction in strain in the conveyors compared to the case where the motor is disposed at an extreme end of the container, and therefore, the conveyor.

In other embodiments of the present invention, the bales are introduced into the container at the approximate center of the container. When the bales are introduced into the container near the drive motor location, the sets of conveyors must reverse direction in order to move the sets of bales to the extreme ends of the container.

A novel aspect of the present invention is the open platform on which to load sets of bales from the side. In the case where the open platform is in the rear, rear loading is another option. Of course, a container may be made to load from the front, approximate middle, and rear. In any case, sets of bales may be loaded from either side of the container.

The term open, for the purposes of this document, including the claims, is hereby defined as without sides. The container of the present invention includes sides—solid, barred, meshed, etc.—to contain the bales of biomass during transport. The loading port, in contradistinction, has no such sides. Bracing along the top of the loading port may or may not be incorporated, but this type of loading port is still termed open.

### BRIEF DESCRIPTION OF THE DRAWINGS

The above mentioned improvement is effected through provision of the method and apparatus described in the following detailed description, particularly when studied in conjunction with the drawings, wherein:

FIG. 1 is a side elevational view of a bale loading container in conjunction with a semi-tractor trailer and constructed for loading sets of bales generally into the rear of the container;

FIG. 2 is a side elevational view of a bale loading container in conjunction with a semi-tractor trailer and constructed for loading sets of bales generally into the approximate middle of the container;

FIG. 3 is a side elevational view of a bale loading container in conjunction with a semi-tractor trailer and constructed for loading sets of bales optionally into the rear or approximate middle of the container;

FIG. 4 is a side elevational view of a bale loading container in conjunction with a straight truck and constructed for loading sets of bales generally into the rear of the container;

FIG. 5 is a top plan form view of a container moving floor comprising chain conveyors;

FIG. 6 is a plan form view of a container moving floor comprising chain conveyors from the underside;

FIG. 7 is a top plan form view of a container moving floor comprising belt conveyors;

FIG. 8 is a plan form view of a container moving floor comprising belt conveyors from the underside;

FIG. 9 is a side elevational view of a bale loading container in conjunction with a semi-tractor trailer wherein sets of bales are shown being loaded generally into the rear of the container;

FIG. 10 is a flow diagram illustrating a procedure for loading the bale loading container;

FIG. 11 illustrates a remote control device;

FIG. 12 is a top plan form view of a container moving floor comprising chain conveyors illustrating a bale stack having been set on the moving floor;

FIG. 13 is a top plan form view of a container moving floor comprising chain conveyors illustrating the bales stack having been advanced out of the loading port area;

FIG. 14 is a top plan form view of a container moving floor comprising chain conveyors illustrating a full bale loading container; and

FIG. 15 is a view like FIG. 14 but with the bale loading container full of bales with the leading edge of the last bale stack between the squeeze flaps which have been actuated so they are in their narrowest position, clamping on the last bale stack, and with a single ratchet strap to secure the load in this configuration.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

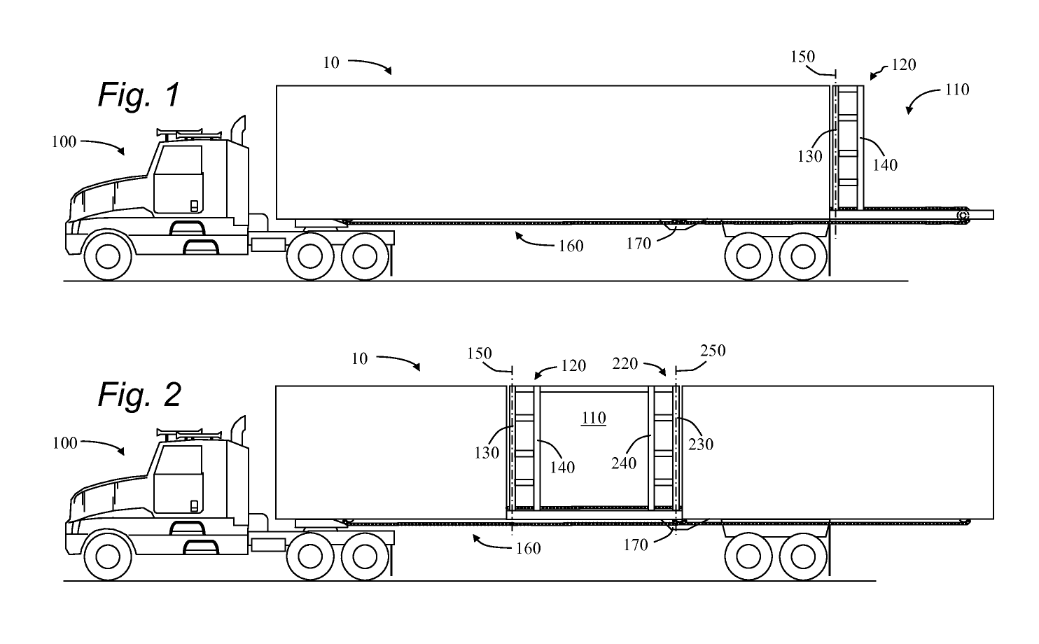

Referring now to the drawings, wherein like reference numerals indicate identical or similar parts throughout the several views, FIGS. 1-15 show preferred embodiments of the present invention.

Referring now to FIG. 1 the bale loading container 10 of the present invention is shown in a configuration wherein it can be conveyed over public and/or private roads from place to place, either empty or loaded by a prime mover 100, such as a semi-tractor, agricultural tractor, etc. The bale loading container 10 includes a loading port 110 disposed generally in the rear portion of the bale loading container 10 for loading and unloading.

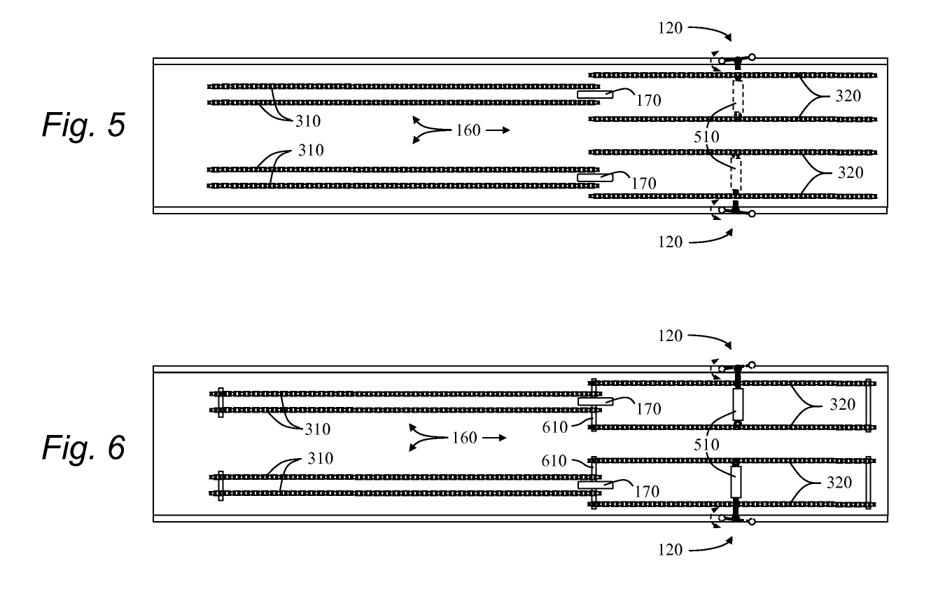

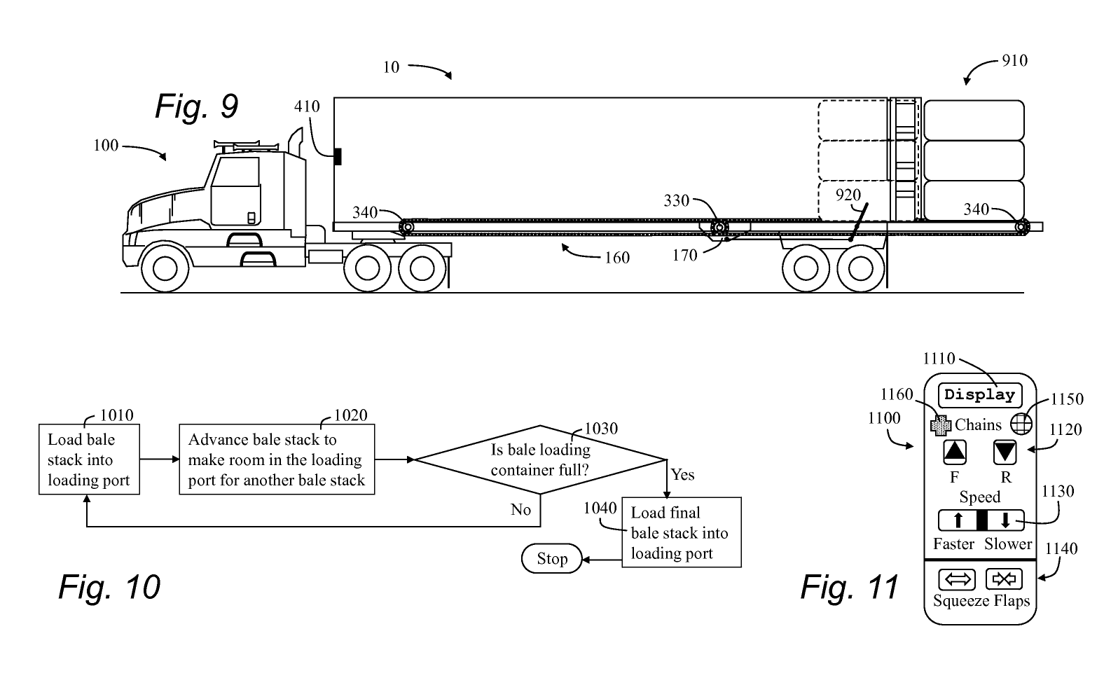

Squeeze flaps 120 are included on both sides in the general front of the loading area to: (1) guide the bale stack 910 (FIG. 9) into the container 10, and (b) to reduce the width, if necessary, of the bale stack 910 by hydraulically actuating the squeeze flaps 120 using actuators 510 (FIG. 5). To effect these goals, the squeeze flaps 120 comprise a front post 130, operatively, pivotally affixed to the bale loading container 10 and a rear post 140, made to swing outward and inward as the front post 130 is rotated about its axis of rotation 150. The squeeze flaps 120 are preferably hydraulically actuated, but may also be electrically or pneumatically actuated.

Bale stacks 910 are transferred from and to the loading port 110 by virtue of conveyors, such as the chain conveyors 160 shown in FIGS. 1-6 and 9. The chain conveyors 160 are driven by a driver 170, which may be hydraulic, pneumatic, electric, or power-take-off driven.

In FIG. 2, the loading port 110 is near the middle of the bale loading container 10. This location of the loading port 110 will be referred to as the center of the container, and is hereby defined as a location such that bale stacks 910 may be transferred both toward the front of the trailer and toward the back of the trailer during loading. Therefore, there is space to store bale stacks 910 fore and aft of the loading port 110. Specifically, the term center as referring to the location of the loading port 110 is not limited to the exact geometric center (one half the length) of the bale loading container 10, nor is it limited to the exact geometric center of the chain conveyors 160.

Squeeze flaps 120 are included on both sides in the general front of the loading area to: (1) guide the bale stack 910 into the container 10, and (2) to reduce the width, if necessary, of the bale stack 910 by hydraulically actuating the squeeze flaps 120.

To effect these goals, the squeeze flaps 120 comprise a front post 130, operatively, pivotally affixed to the bale loading container 10 and a rear post 140, made to swing outward and inward as the front post 130 is rotated about its axis of rotation 150. The squeeze flaps 120 are preferably hydraulically actuated.

Squeeze flaps 220 are included on both sides in the general rear of the loading area to: (1) guide the bale stack 910 into the container 10, and (b) to reduce the width, if necessary, of the bale stack 910 by hydraulically actuating the squeeze flaps 220. To effect these goals, the squeeze flaps 220 comprise a rear post 230, operatively, pivotally affixed to the bale loading container 10 and a front post 240, made to swing outward and inward as the rear post 230 is rotated about its axis of rotation 250. The squeeze flaps 220 are preferably hydraulically actuated, but may be pneumatically or electrically actuated, instead.

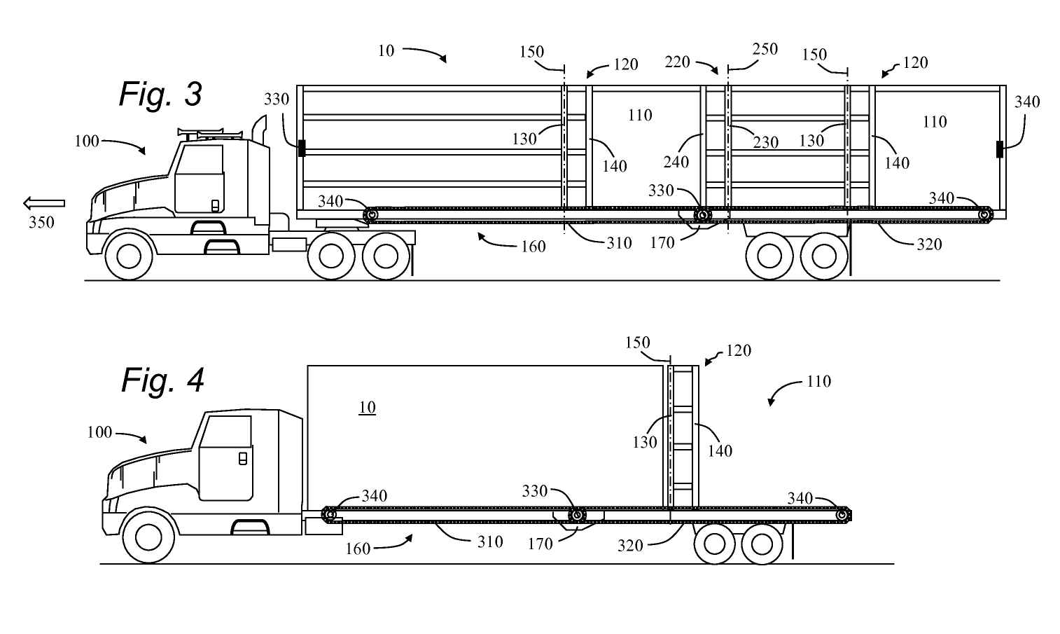

The bale loading container 10 shown in FIG. 3 allows for loading and unloading to be accomplished at two loading ports 110. One is center located while the other is located generally at the rear of the bale loading container 10.

Details of the chain conveyors 160 and the driver 170 are shown more completely in FIGS. 3, 4, and 9 where some of the floor of the bale loading container 10 has been made transparent. The driver 170 is located such that there are chains both fore and aft of the driver 170. This location of the driver 170 will be referred to as the center of the container 10, and is hereby defined as a location such that chain conveyors are driven thereby both fore and aft of the driver 170. Specifically, the term center as referring to the location of the driver 170 is not limited to the exact geometric center (one half the length) of the bale loading container 10, nor the exact geometric center of the chain conveyors 160.

Compared to driving the chain conveyors 160 from one extreme end of the bale loading container 10, an advantage to driving the chain conveyors 160 in the center of the bale loading container 10 is the strain on the chains is reduced.

Drive cogs 330 are employed at the driver 170 to engage the chain conveyors 160 and provide slipless drive. Outboard cogs 340 are engaged by the chain conveyors 160 at their respective extreme ends.

The term forward is herein defined for the purposes of this document, including the claims, as the principle direction the bale loading container 10 is conveyed by the prime mover 100. An arrow indicating the forward direction 350 is shown in FIG. 3. In particular, the forward chain conveyors 310 are located in the forward direction from the driver 170. The term aft is defined as the opposite direction of forward.

A sensor 330, 340 is included at each end of the bale loading container 10 toward which bale stacks 910 travel during loading. In a preferred embodiment, only one such sensor 330, 340 is included, and that at the forward end of the bale loading container 10, as shown in FIG. 9. The sensor 330, 340 signals the driver 170 to stop conveying the bale stacks 910 when the forward-most bale stack 910 reaches an associated far end of the bale loading container 10. It should be clear that the bale loading container 10 of FIG. 1 needs only one sensor 330, located at the forward end of the bale loading container 10 as this is the only end toward which bale stacks 910 travel upon loading.

An alternative configuration is shown in FIG. 4, where the bale loading container 10 is transported on a straight truck. The bale loading container is not limited to any particular prime mover used to transfer the same from place to place.

The chain conveyors 160 are shown from the top in FIG. 5. The chains appearing in this view contact the bale stacks 910 for the purpose of conveying the bale stacks 910 through the bale loading container 10 for loading and unloading.

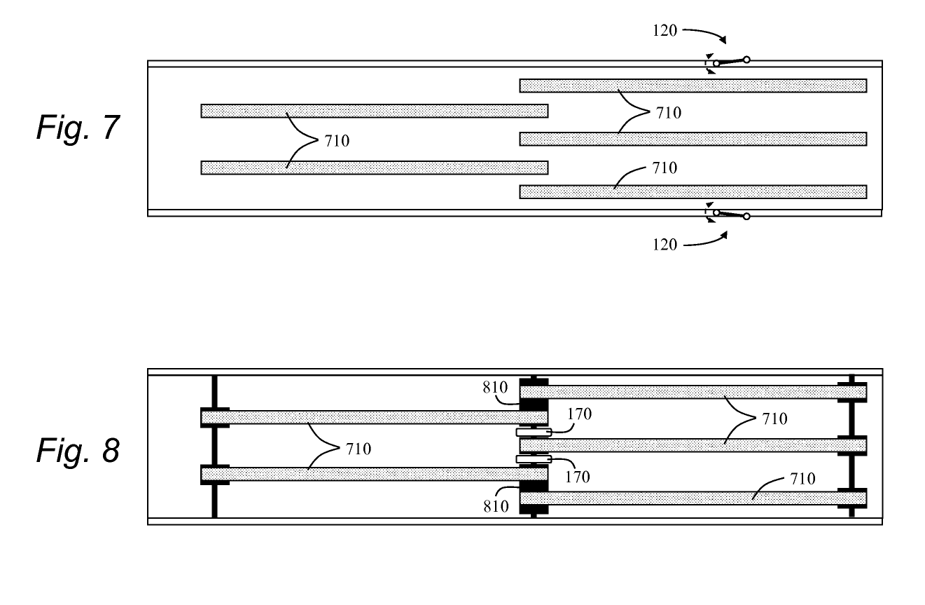

It is noted that the conveyors 160 are illustrated as roller chain conveyors, but web chains or belts 710, such as those shown in FIGS. 7 and 8, may be used instead of the roller chain conveyor belts. Chain conveyor systems may be similar to the gathering chains 410 shown in FIG. 5 of U.S. Pat. No. 8,734,077 to a Bale Picking Truck by Kelderman, incorporated herein in its entirety by reference.

The underside of the chain conveyors 160 is shown in FIG. 6. Here, it can be seen how each driver 170 simultaneously drives forward chain conveyors 310 and aft chain conveyors 320 via shafts 610. Cogs 330 are affixed to the shafts 610, which engage the chain conveyors 160 to provide drive without slip.

An alternate embodiment of the present invention is shown in FIGS. 7 and 8. Instead of chain conveyors 160, conveyor belts 710 are used to move bale stacks 910 into and out of the bale loading container 10. The belts engage belt pulleys 810, the belt pulleys 810 being driven by the driver 170.

Stacks of bales 910 are shown being loaded into the open loading port 110 in FIG. 9. A stack of bales may comprise, for instance, six bales—two wide and three high. The bales are set on the platform of the loading port 110 using a fork lift, bale spear, bale squeeze, or any other device capable of lifting at least one bale to the platform.

The procedure for loading the bale loading container 10 is illustrated in FIG. 10. In step 1010, a bale stack 910 is set on the platform of the bale loading container 10. The operator, or other person involved in the loading process, uses a remote 1100 such as that shown in FIG. 11, or a lever 920, pushbutton (not shown), or other control action to actuate the drive 170, causing the chain conveyors 160 to move the bale stack 910 adequately to clear the platform of the open loading port 110 to make room for another bale stack 910, as shown in step 1020. If the bale loading container 10 is full 1030, as indicated by the sensor 330, 340, or by counting the bale stacks 910 already loaded, a final bale stack 910 is loaded onto the platform of the bale loading container 10, as indicated in step 1040. If possible, this last bale stack 910 is advanced sufficiently to enter the squeeze flaps 120, and the squeeze flaps 120 narrowed at the end opposite the pivot axis 150 to hold the last bale stack securely for transport.

If the bale loading container 10 is not full at comparison block 1030, the process is repeated, starting with step 1010 where a bale stack 910 is set on the platform of the bale loading container 10.

The example remote control unit 1100 shown in FIG. 11, includes a display 1110 for warnings and other feedback, forward (F) and reverse (R) chain conveyor controls 1120, chain conveyor speed control 1130, and squeeze flap control 1140. It is to be understood, this is only an example. The remote control device 1100 is not limited to these functions, nor are all these functions necessarily part of the present invention. The remote control device 1100 may be wired or wireless.

The display 1110 of the remote control unit 1100 may be used to indicate the bale loading container 10 is full. However, that information may also be provided by a sound, emanating from a sound generator 1150, or vibration, generated by a vibrator 1160, both detectable by the operator.

Unloading the bale loading container 10 may be accomplished by reversing the loading process. The driver 170 is necessarily reversible. Typically, the bale stacks 910 are unloaded from the rear of the bale loading container 10, even if they are loaded into the center.

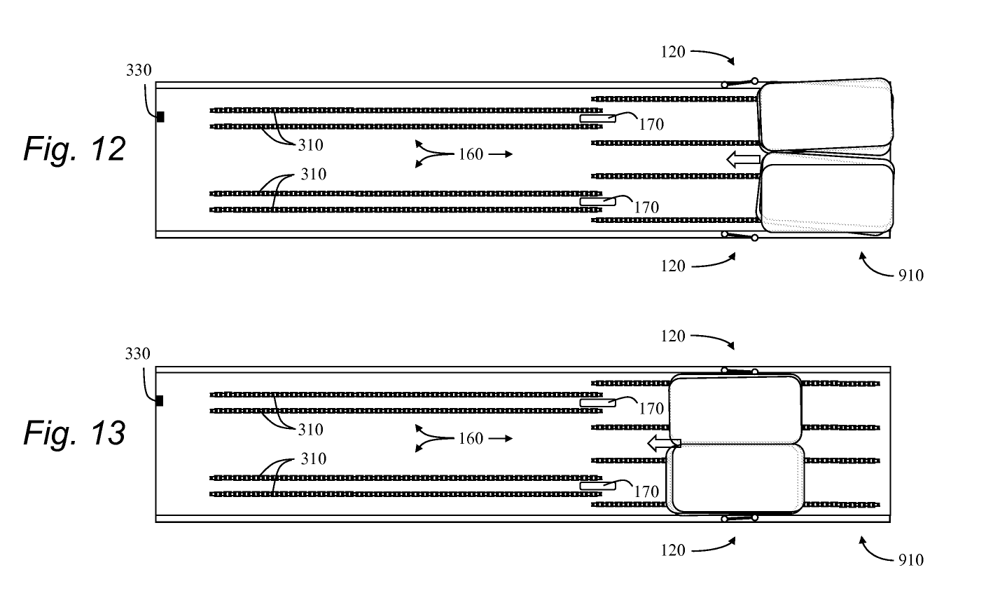

The action of the squeeze flaps 120 is illustrated in FIGS. 12-15. The bale stacks 910 in these figures are shown in a semi-transparent state so the conveyor system 160, 170 and squeeze flaps 120 may be seen. In FIG. 12, a bale stack 910 has been set on the platform of the bale loading container 10, ready for loading. Note that the bales are not well aligned with the sides of the bale loading container 10.

The bale stack 910 is then advanced in the direction of the arrow, as shown in FIG. 13. Due to the need for alignment, the squeeze flaps 120 are pivoted inward on the pivot axis 150 (not shown in FIGS. 12-15), thus forcing the bales inward. The result is better alignment and a narrower footprint of the bale stack 910. When individual bales have broadened due to being stacked on or other influences, the squeeze flaps 120 are brought to bear to reduce the breadth of the overall bale stack 910, and hence, the individual bales.

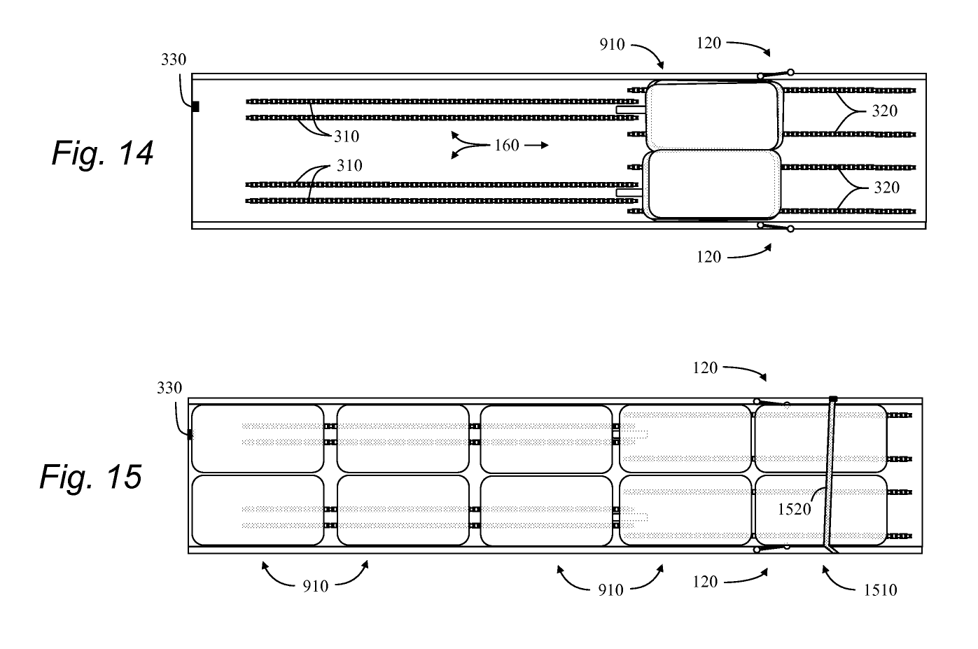

In FIG. 14, the bale stack has been aligned and cleared out of the loading port 110. The squeeze flaps 120 have been returned to their broadened position where they can act as a funnel to direct bale stacks not needing much alignment or narrowing.

The bale loading container 10 has been filled in FIG. 15. The sensor 330 has sensed the proximity of a bale stack and signaled the operator. In response to this signal, the operator has loaded a last bale stack 1510 and advanced it so the leading edge of the last bale stack 1510 resides between the squeeze flaps 120. The squeeze flaps 120 have been actuated so they are in their narrowest position, clamping on the last bale stack 1510. A single ratchet strap 1520 is typically all that is required to secure the load in this configuration.

In the event the last bale stack 1510 cannot be advanced sufficiently to bring its leading edge between the squeeze flaps 120, a second ratchet strap 1520 is typically applied to the last bale stack 1510 in order to secure the same.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. A method of loading a bale loading container, the method comprising:
(a) disposing a conveyor driver at a center of the bale loading container;
(b) operatively rotatively affixing at least one forward conveyor to the conveyor driver, said at least one conveyor being disposed in a forward direction from the conveyor driver;
(c) operatively, rotatively affixing at least one aft conveyor to the conveyor driver, said at least one conveyor being disposed in an aft direction from the conveyor driver;
(d) setting at least one bale into a loading port; and
(e) actuating the conveyor driver to move said at least one bale out of the loading port.

2. The method of claim 1, wherein the at least one forward conveyor and the at least one aft conveyor comprise chain conveyors, the method further comprising:
(a) operatively affixing a first cog to the conveyor driver;
(b) engaging the at least one forward conveyor with the first cog;
(c) operatively affixing a second cog to the conveyor driver; and
(d) engaging the at least one aft conveyor with the second cog.

3. The method of claim 1, wherein the at least one bale comprises a first bale, the method additionally comprising:
(a) setting an additional at least one bale into the loading port;
(b) actuating the conveyor driver; and
(c) repeating the setting and the actuating until said bale loading container is full.

4. The method of claim 1, wherein actuating the conveyor driver comprises signaling the conveyor driver with a remote control device.

5. The method of claim 3, additionally comprising:
(a) disposing a sensor at an end of the bale loading container;
(b) sensing when the at least one bale reaches the end of the bale loading container with the sensor; and
(c) signaling an operator that the bale loading container is full.

6. The method of claim 1, further comprising disposing the loading port at a location selected from the group consisting of a rear and a center of the bale loading container.

7. The method of claim 1, further comprising conveying the bale loading container using a prime mover.

8. The method of claim 7, wherein the prime mover comprises a semi-tractor.

9. The method of claim 7, wherein the prime mover comprises a straight truck.

10. The method of claim 1, wherein the at least one forward conveyor and the at least one aft conveyor comprise belt conveyors, the method further comprising:
(a) operatively affixing a first belt pulley to the conveyor driver;
(b) engaging the at least one forward conveyor with the first belt pulley;
(c) operatively affixing a second belt pulley to the conveyor driver; and
(d) engaging the at least one aft conveyor with the second belt pulley.

11. The method of claim 5 wherein signaling the operator that the bale loading container is full comprises:
(a) sending a full-container signal receivable by a remote apparatus; and
(b) providing the operator information via the remote apparatus.

12. The method of claim 11, wherein the information provided to the operator via the remote apparatus is provided by one of the signals selected from the group consisting of a display, a sound, and a vibration.

13. The method of claim 1 wherein the at least one bale comprises at least one bale of biomass material.

14. The method of claim 1, wherein the bale loading container comprises squeeze flaps, the method additionally comprising compressing the at least one bale with the squeeze flaps as said at least one bale is moved out of the loading port.

15. An apparatus for loading a bale loading container, the apparatus comprising:
(a) at least one forward bale conveyor disposed substantially within the bale loading container;
(b) at least one aft bale conveyor, at least some of said at least one aft bale conveyor disposed within the bale loading container; and
(c) a conveyor driver, said conveyor driver disposed between the at least one forward bale conveyor and the at least one aft bale conveyor and used to drive the at least one forward conveyor and the at least one aft conveyor.

16. The apparatus of claim 15 wherein the at least one forward bale conveyor comprises at least one forward chain conveyor and the at least one aft bale conveyor comprises at least one aft chain conveyor, the apparatus additionally comprising:
(a) at least one forward drive cog, operatively rotatably connected to the conveyor driver and engaged to the at least one forward chain conveyor; and
(b) at least one aft drive cog, operatively rotatably connected to the conveyor driver and engaged to the at least one aft chain conveyor.

17. The apparatus of claim 15 wherein the at least one forward bale conveyor comprises at least one forward belt conveyor and the at least one aft bale conveyor comprises at least one aft belt conveyor, the apparatus additionally comprising:
(a) at least one forward drive belt pulley, operatively rotatably connected to the conveyor driver and engaged to the at least one forward belt conveyor; and
(b) at least one aft drive belt pulley, operatively rotatably connected to the conveyor driver and engaged to the at least one aft belt conveyor.

18. The apparatus of claim 15 additionally comprising an loading port into which to load at least one bale, said loading port being traversed by one of the at least one bale conveyors selected from the group the at least one forward bale conveyor and the at least one aft bale conveyor.

19. The apparatus of claim 18 wherein the loading port is disposed at a location selected from the group, center of the bale loading container and rear of the bale loading container.

20. The apparatus of claim 15 additionally comprising at least one squeeze flap, said at least one squeeze flap comprising:
(a) a first post, operatively pivotally attached to the bale loading container about an axis of pivot;
(b) a second post, operatively rigidly affixed to the first post;
(c) at least one hydraulic actuator, operatively pivotally attached to the at least one squeeze flap and disposed to cause said at least one squeeze flap to pivot about the axis of pivot.

21. The apparatus of claim 15 additionally comprising a sensor disposed at an end of the bale loading container and configured to sense a proximity of a bale.

22. The apparatus of claim 15 additionally comprising a remote control device for remotely actuating the conveyor driver.

23. The apparatus of claim 18 wherein the loading port is open.
